(19) United States
(12) Patent Application Publication
(10) Pub. No.: US 2011/0090292 A1
(43) Pub. Date: Apr. 21, 2011

(54) INK-JET IMAGE RECORDING APPARATUS

(75) Inventor: Tadashi IWASAKI, Hachioji-shi (JP)

(73) Assignee: OLYMPUS CORPORATION, Tokyo (JP)

(21) Appl. No.: 12/907,174

(22) Filed: Oct. 19, 2010

(30) Foreign Application Priority Data
Oct. 21, 2009 (JP) 2009-242704

(51) Int. Cl. B41J 2/175

(52) U.S. Cl. 347/85

(57) ABSTRACT

An ink-jet image recording apparatus is configured so that a sufficient hydraulic head difference can be secured to prevent ink overflow, and a pump on an ink feeding path leading to a recording head is driven to feed an ink toward the head, thereby pressuring overloaded nozzles to set a pressure for the formation of suitable menisci.

### CROSS-REFERENCE TO RELATED APPLICATIONS

This application is based upon and claims the benefit of priority from prior Japanese Patent Application No. 2009-242704, filed Oct. 21, 2009, the entire contents of which are incorporated herein by reference.

### BACKGROUND OF THE INVENTION

1. Field of the Invention

The present invention relates to an ink-jet image recording apparatus comprising an ink supply mechanism.

2. Description of the Related Art

In general, in an ink-jet image recording apparatus, such as an ink-jet printer, a very small amount of ink is discharged from a large number of fine nozzle holes in a nozzle face of a recording head, and a desired image is recorded by jetting the discharged ink onto a recording medium.

Recording heads of known types comprise an ink supply mechanism in which ink from an ink cartridge in a head body is supplied to nozzles or ink from a separate ink tank is fed into the head through an ink path, such as an ink tube. Those recording heads which are fitted with the ink cartridge are frequently used as scan-type recording heads configured to scan a moving recording medium. On the other hand, those heads to which the ink supply mechanism with the ink tank is connected are generally used as line-type recording heads that are expected to perform a lot of recording.

In the ink supply mechanism with the ink tank, a negative pressure needs to be produced in the recording head (on the ink ejection side) to form menisci in the nozzles of the recording head. In forming the menisci by means of the ink weight or gravity, a hydraulic head difference is produced by locating a main tank for ink supply and a sub-tank gravitationally higher and lower, respectively, than the nozzle face of the recording head to produce a negative pressure in the head. Suitable menisci can be formed in the head by adjusting the respective heights of the tanks.

Depending on the configurations of the mounted recording head, ink supply system, etc., however, a hydraulic head difference may have to be produced, so that the image recording apparatus may be enlarged in some cases. In order to install the image recording apparatus or mount it in another manufacturing apparatus in a limited space, the recording apparatus is expected to be smaller than the space.

A technique for maintaining menisci is proposed in, for example, Jpn. Pat. Appln. KOKAI Publication No. 2007-203649. According to this technique, an intake/exhaust pump is used to produce a negative pressure that acts on a recording head, and this negative pressure is changed by adjusting the liquid level of a sub-tank based on an elevational movement of the head. Thus, a variable negative pressure is produced without being restricted by a hydraulic head difference, and pressure control is appropriately performed according to the recording state of the recording head. In this way, the recording head is subjected to a constant negative pressure.

### BRIEF SUMMARY OF THE INVENTION

According to an aspect of embodiments, there is provided an ink-jet image recording apparatus comprising: a recording head comprising a plurality of nozzles which discharge an ink; a sub-tank communicating with the recording head through an ink path member and stored with the ink; a pump provided in the middle of the ink path member and configured to supply the ink in the sub-tank to the recording head, the respective height levels of the surface of the ink in the sub-tank and the nozzles of the recording head and the surface of the ink in the sub-tank being set so that a pressure in the nozzles with the pump off is more negative than a negative pressure at which menisci for the ink discharge are formed, the pressure in the nozzles being adjusted to the negative pressure at which the menisci for the ink discharge are formed by means of a positive pressure produced by the pump which is driven to discharge the ink from the recording head.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a conceptual configuration example of an ink-jet image recording apparatus according to a first embodiment of the invention;

FIG. 2A is a diagram showing a positional relationship between a nozzle face and the highest position of an ink surface in a normal state;

FIG. 2B is a diagram showing a positional relationship between the nozzle face and the ink surface located higher than the nozzle face by tilting;

FIG. 3A is a diagram showing a gauge static pressure distribution in an ink non-circulation state with a pump off according to the first embodiment;

FIG. 3B is a diagram showing a gauge static pressure distribution in an ink circulation state with the pump on;

FIG. 4 is a block diagram showing a conceptual configuration example of an ink-jet image recording apparatus according to a modification of the first embodiment;

FIG. 5A is a diagram showing a gauge static pressure distribution in an ink non-circulation state with a pump off according to the modification of the first embodiment;

FIG. 5B is a diagram showing a gauge static pressure distribution in an ink circulation state with the pump on;

FIG. 6 is a block diagram showing a conceptual configuration example of an image recording apparatus according to a second embodiment;

FIG. 7A is a diagram showing a gauge static pressure distribution in an ink non-circulation state with a pump off according to the second embodiment;

FIG. 7B is a diagram showing a gauge static pressure distribution in an ink circulation state with the pump on;

FIG. 8 is a block diagram showing a conceptual configuration example of an image recording apparatus according to a third embodiment;

FIG. 9A is a diagram showing a gauge static pressure distribution in an ink non-circulation state with a pump off according to a modification of the third embodiment; and

FIG. 9B is a diagram showing a gauge static pressure distribution in an ink circulation state with the pump on.

### DETAILED DESCRIPTION OF THE INVENTION

Embodiments of the present invention will now be described in detail with reference to the accompanying drawings.

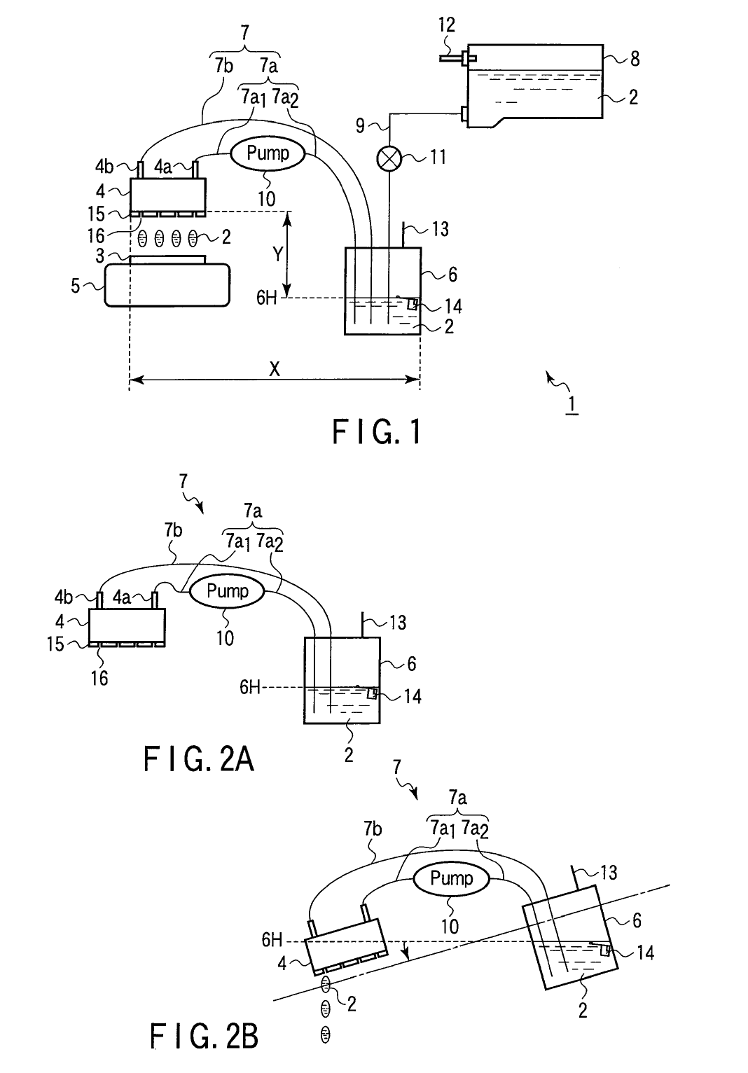

FIG. 1 is a block diagram showing a conceptual configuration example of an ink-jet image recording apparatus (hereinafter referred to as an image recording apparatus) according to a first embodiment of the invention. In the following, only those constituent members of the image recording apparatus which are associated with features (or the spirit) of the invention will be described. However, the apparatus is assumed to comprise conventional constituent members, such as a recording medium feeding mechanism, eject mechanism, maintenance mechanism, control display mechanism, etc. An available ink liquid according to the present embodiment may be an ink that is higher in specific gravity than water and contains titanium oxide or the like as a color material. Alternatively, the ink may be one that contains ethylene glycol or glycerin as a solvent. In the description to follow, the difference in level or elevation is regarded as gravitational.

The image recording apparatus 1 comprises a recording head 4, transport mechanism 5, sub-tank 6, ink circulation path 7, main tank 8, ink supply path 9, pump 10, and solenoid valve 11. The recording head 4 discharges an ink 2 to record an image on a recording medium 3. The transport mechanism 5 conveys the recording medium 3. The sub-tank 6 contains the ink 2 to be supplied to the recording head 4. The ink circulation path 7 comprises two ink paths, a first ink path 7a (including a pump communication path 7a2) and second ink path 7b between the sub-tank 6 and recording head 4, and serves to circulate the ink 2. The main tank 8 supplies the ink 2 to the sub-tank 6. The ink supply path 9 connects the main tank 8 and sub-tank 6. The pump 10 is provided in the middle of one ink path of the ink circulation path 7. The solenoid valve 11 is provided in the middle of the ink supply path 9. The recording head 4, transport mechanism 5, pump 10, solenoid valve 11, etc., are individually controlled by a controller (not shown).

In these configurations, the recording head 4 comprises a nozzle face (or nozzle plate) 15 in which a plurality of nozzles 16 are formed. The nozzles 16 discharge drops of the ink 2 gravitationally downward. The nozzle face 15 is disposed so as to face the recording medium 3 being conveyed.

The recording head 4 comprises first and second ink ports 4a and 4b through which the ink is fed into or ejected from the head. The ink ports 4a and 4b communicate with a common ink chamber. If either one of the ink ports 4a and 4b is on the ink supply side, the other is on the ink ejection side. The flow of the ink 2 to be supplied or ejected can be redirected by reversing the ink feed by the pump 10. If the recording head is of a type such that the direction of the ink flow therein is fixed, the positions of connection between the ink paths 7a and 7b and ink ports 4a and 4b should only be reversed. In the present embodiment, the ink paths 7a and 7b are each formed of a tubular member, such as a metallic or resin tube. Further, the tube diameter can be appropriately selected according to designs and specifications.

In the present embodiment, the first and second ink paths 7a and 7b of the ink circulation path 7 are connected to the ink ports 4a and 4b, respectively. For better understanding, in the description to follow, the first ink path 7a is assumed to be an ink path through which the ink 2 is supplied to the recording head 4 and to comprise an ink feeding path 7a1 and pump communication path 7a2. The ink feeding path 7a1 connects the ink port 4a and pump 10. The pump communication path 7a2 extends from the sub-tank 6 to the pump 10. The second ink path 7b will be described as an ink ejection path 7b, which is connected to the ink port 4b and through which flows the ink ejected from the recording head 4 into the sub-tank 6 without being discharged from the nozzles.

The transport mechanism 5 is opposed to the recording head 4 so that the conveyed recording medium 3 passes opposite the nozzle face 15 of the head 4. The transport mechanism 5 rotates, for example, an annular belt by rotating a plurality of pulleys on which the belt is wound and supported. A plurality of holes are bored in the belt so as to cover its entire surface. The recording medium 3 is drawn to and conveyed by the belt under a negative pressure produced by a fan or the like inside the belt. Alternatively, an elongated recording medium may be sandwiched between a pair of rollers arranged individually upstream and downstream relative to the direction of conveyance as it is conveyed.

The main tank 8 is located higher than the recording head 4. It should only be located high enough to keep the ink in the recording head 4 and ink circulation path 7 from flowing back into the main tank 8 when the solenoid valve 11 is opened. The main tank 8 comprises a vent hole 12, which is normally open to the atmosphere. The main tank 8 may be of, for example, a cartridge type that can be removed from the ink supply path 9 and replaced with a new one filled with the ink when emptied.

Further, the sub-tank 6 comprises a vent hole 13, which is normally open to the atmosphere. A liquid-level sensor 14 is provided in the sub-tank 6 and used to detect the level of an ink surface 6H. The sensor 14 comprises, for example, a float floating on the ink surface and is configured to detect the ink surface level by the position of the float. In this case, the sub-tank 6 is located gravitationally lower than the recording head 4 so that the highest position of the ink surface 6H is lower than the nozzle face 15.

The solenoid valve 11 is normally closed except during ink supply. The ink 2 is consumed as it is discharged for the recording medium or maintenance. The valve 11 is opened if the amount of residual ink (or the level of the ink surface 6H) in the sub-tank 6, detected by the liquid-level sensor 14 under the control of the controller (not shown), falls below a predetermined level as a result of the consumption. Thereupon, the ink to be supplied flows down from the main tank 8 to the sub-tank 6 through the ink supply path 9. If the ink surface 6H reaches the predetermined level, which is indicative of the completion of the supply, the valve 11 is closed, whereupon the ink supply is stopped.

The respective other end openings of the first ink path 7a (or the pump communication path 7a2) and second ink path 7b of the ink circulation path 7 extend to the vicinity of a bottom surface in the sub-tank 6. This arrangement facilitates an effective use of the ink in the sub-tank.

In the present embodiment, the pump 10 is located higher than the recording head 4 in the middle of the first ink path 7a. By its forward or reverse rotation, the pump 10 can cause the ink in the first ink path 7a to flow toward either the main tank 8 or the sub-tank 6. Although the pump 10 should preferably be a non-pulsating pump, such as a propeller pump, it is not limited to this. A pulsating pump, such as a tube pump, diaphragm pump, or piston pump, may alternatively be used only if it is combined with an appropriate damper.

The ink can be circulated by driving the pump 10 to form the ink circulation path 7 that comprises the pump 10, first ink path 7a, recording head 4, second ink path 7b, sub-tank 6, and first ink path 7a. If necessary, a foreign matter filter, temperature controller, degasser, etc., may be arranged on the ink circulation path 7.

The following a description of an ink discharging operation of the ink-jet image recording apparatus constructed in this manner.

In starting discharge of drops of the ink 2 toward the recording medium 3, the image recording apparatus 1 circulates the ink 2 in the ink circulation path 7 by the drive of the sub-tank 6, thereby forming menisci suitable for the ink discharge. The process of formation of the menisci will be described in detail later. When the ink discharging operation is not expected, the pump 10 is not activated and the ink is not circulated in, for example, an image data standby mode, user-suspended state, or unpowered state. Although it may be assumed that suitable menisci for discharge are not formed in this state, such a situation causes no problem, since image recording is not expected.

The following is a description of a meniscus forming method for the nozzles 16.

While menisci need to be formed in order to discharge the ink from the nozzles 16, there is a known technique for forming suitable menisci based on a hydraulic head difference between the ink surface 6H and nozzles 16 (or nozzle face 15).

As shown in FIG. 1, the sub-tank 6 is located so that a predetermined distance is kept between the highest position of the ink surface 6H and the nozzle face 15. It is assumed, for example, that the distance between the recording head 4 and sub-tank 6, which depends on the size of the recording medium 3, is X and the difference between the nozzle face 15 and the highest position of the ink surface 6H is Y.

In the case where the distance between the highest position of the ink surface 6H and the nozzle face 15 is less than the predetermined distance, the ink 2 overflows the nozzles 16 when the ink surface 6H gets higher than the nozzle face 15, as shown in FIG. 2B, if the image recording apparatus is subjected to tilting, vibration, or impact with the ink circulation path 7 non-circulatory, as shown in FIG. 2A.

Thus, the ink circulation path 7 is positioned so that an angle arctan(Y/X) defined by the distance X and difference Y is more than an allowable tilt angle in the installation position of the image recording apparatus 1 or during transportation.

In the present embodiment, the highest position of the ink surface 6H and the nozzle face 15 are kept at the predetermined distance or more from each other so that there is the head difference Y between the nozzle face 15 and ink surface 6H that does not cause overflow of the ink due to position reversal if the apparatus is tilted at, for example, several degrees during transportation.

In the case where the ink with a high specific gravity is used, as mentioned before, however, suitable menisci cannot be formed if the hydraulic head difference is increased to prevent ink leakage with priority. Conversely, if the head difference is reduced, the possibility of the ink overflowing the nozzles 16 increases.

According to the present embodiment, the image recording apparatus is proposed in which a heavy ink is used as the ink 2 such that ink overflow from the nozzles 16 cannot be caused if the apparatus is subjected to tilting, vibration, or impact, and in which the suitable menisci for the ink discharge are formed in the nozzles 16 by the pump as the ink is circulated. The following is a specific description of this apparatus.

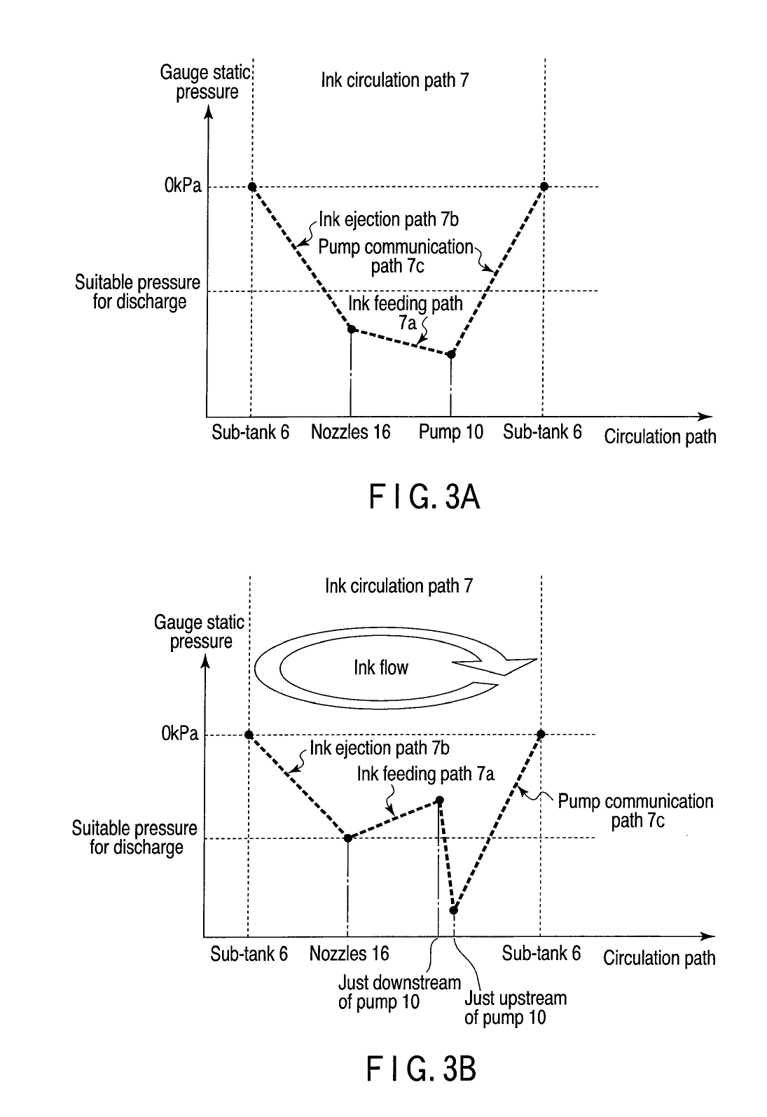

FIG. 3A shows a gauge static pressure distribution in an ink non-circulation state with the pump 10 off, and FIG. 3B shows a gauge static pressure distribution in an ink circulation state with the pump 10 on.

If the pump 10 is driven, the ink 2 is assumed to flow from the sub-tank 6 toward the recording head 4 in the first ink path 7a.

When the pump 10 is stopped, the ink stagnates and does not flow in the ink circulation path 7, so that the gauge static pressure is proportional to the height above the ink surface 6H, as shown in FIG. 3A.

Since the sub-tank 6 is open to the atmosphere, its gauge static pressure is 0 kPa. Since the nozzles 16 and pump 10 are located higher than the ink surface 6H, their internal pressures are negative pressures corresponding to their heights. In the present embodiment, the ink 2 has a high specific gravity and the difference in level between the nozzle face 15 and ink surface 6H is more than the predetermined distance, so that the nozzle pressure is more negative than a pressure that is suitable for the discharge. Thus, suitable menisci are not formed.

If the pump 10 is driven with a predetermined driving force, the gauge static pressure of the nozzles 16 increases, as shown in FIG. 3B. Since the pump 10 is driven so that the ink flows toward the nozzles 16, positive and negative pressures just downstream and upstream of the pump 10 become more positive and negative, respectively, than before the pump 10 is driven. Consequently, the gauge static pressure of the nozzles 16 shifts to the positive-pressure side and increases up to the suitable pressure for the discharge.

The driving force of the pump 10 for increasing the gauge static pressure of the nozzles 16 to the suitable pressure for the discharge is not fixed and varies depending on the specifications of the ink circulation path 7, that is, constituent parts on the path, piping diameter, lead-around shapes of pipes (ink flow passages). The driving force is influenced by the difference in level between the nozzles 16 and ink surface 6H, the type and performance of the pump, and the configuration of the ink circulation path 7 comprising the first and second ink paths 7a and 7b, and depends on various physical properties, such as the density, viscosity, surface tension, etc., of the ink 2 used. Therefore, an actual measurement or simulation is previously empirically performed to obtain an optimum driving force in advance.

According to the present embodiment, as described above, the highest position of the ink surface 6H and the nozzles 16 are kept at the predetermined distance or more in order to prevent ink overflow from the nozzles 16 due to tilting, vibration, or impact to which the apparatus is subjected during a non-recording mode. If the hydraulic head difference between the ink surface 6H and nozzles 16 cannot produce the suitable pressure for the discharge in the nozzles 16 during an image recording mode, moreover, the ink 2 is circulated in the ink circulation path 7 by the pump 10. In this way, the suitable pressure for the discharge can be set in the nozzles 16 to form optimum menisci. Thus, the suitable pressure (or menisci) for the ink discharge can be set in the nozzles 16 without failing to overcome tilting, vibration, or impact to which the image recording apparatus is subjected.

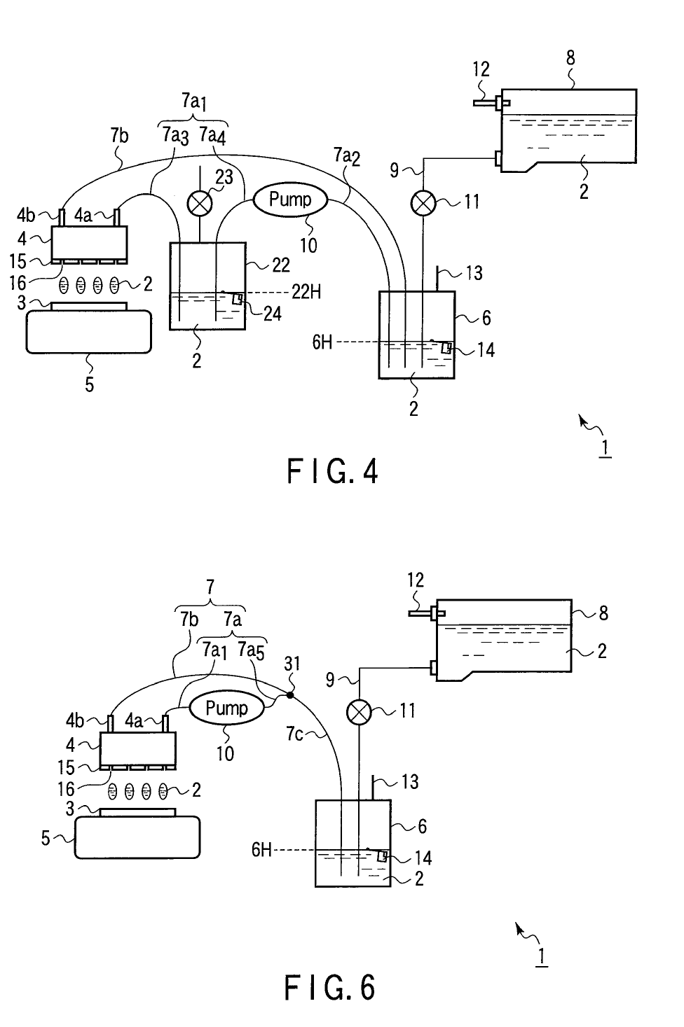

A modification of the first embodiment will now be described with reference to FIG. 4.

This modification differs from the first embodiment in that a second sub-tank is mounted on an ink path 7a between a pump and recording head. FIG. 4 is a block diagram showing a configuration of an image recording apparatus according to the modification. Like reference numbers refer to like portions in the first embodiment and the modification, and a description of those portions is omitted. The following is a description of only different portions of the modification.

An image recording apparatus 21 of this modification comprises a second sub-tank 22 on an ink feeding path 7a1 (comprising an ink feeding path 7a3 and second pump communication path 7a4) between a pump 10 and recording head 4. The second sub-tank 22 is provided with a solenoid valve 23 and liquid-level sensor 24 (equivalent to the liquid-level sensor 14) that is used to detect the level of an ink surface.

The solenoid valve 23, along with the solenoid valve 11, is closed while the ink 2 is not being circulated and is opened to the atmosphere while the ink is being circulated. The second sub-tank 22 supplies the ink 2 to the recording head 4 after it is temporarily stored with the ink drawn from a sub-tank 6 by the pump 10. Both the solenoid valve 23 and the solenoid valve 11 are closed in the non-circulation state during transportation or displacement of the apparatus. Thus, ink overflow from nozzles due to tilting of the apparatus is prevented according to the hydraulic head difference.

An ink surface 22H that ascends and descends in the second sub-tank 22 is normally located higher than an ink surface 6H of the sub-tank 6 and lower than a nozzle face 15 of the recording head 4. However, the range of vertical motion of the ink surface 22H also covers a position higher than the nozzle face 15 and a position lower than the highest position of the ink surface 6H. If the flow resistance of the ink feeding path 7a3 is high, for example, the ink surface 22H may be located higher than the nozzle face 15. In this case, the ink feed rate is reduced to prevent ink overflow from the second sub-tank 22 by controlling the pump 10.

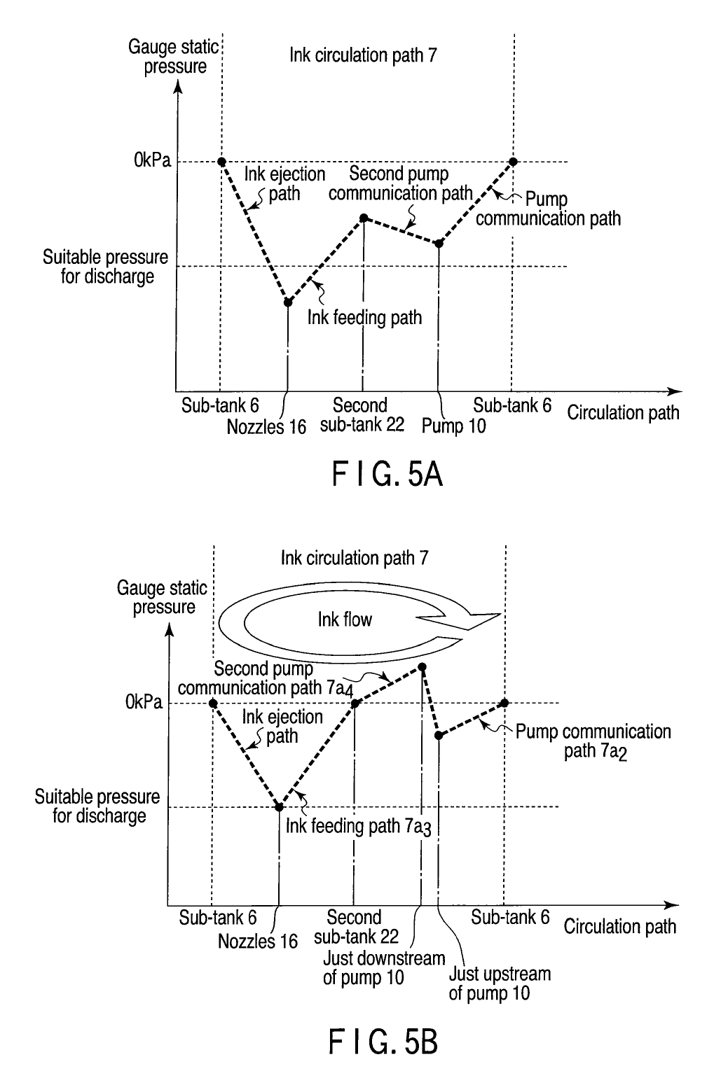

FIG. 5A shows a gauge static pressure distribution in an ink non-circulation state with the pump 10 off according to the modification, and FIG. 5B shows a gauge static pressure distribution in an ink circulation state with the pump 10 on.

In the non-circulation state shown in FIG. 5A, the solenoid valve 23 is closed, so that the internal pressure of the second sub-tank 22 is a gauge negative pressure that is less than the atmospheric pressure. In FIG. 5B, the solenoid valve 23 is open so that the interior of the second sub-tank 22 is open to the atmosphere. If the pump 10 is driven to circulate the ink, the second sub-tank is substantially pressurized, which is not the case with the non-circulation state. Thus, the pressure in the nozzles 16 is increased to a suitable level, so that appropriate menisci are formed in the nozzles 16, whereupon the ink 2 is discharged.

In this modification, the ink can be discharged with appropriate menisci formed by the pump drive. Further, the second sub-tank serves to mitigate pulsation in the ink feed by the pump, so that the ink can be smoothly fed into the recording head.

FIG. 6 is a block diagram showing a conceptual configuration example of an image recording apparatus according to a second embodiment of the invention. Like reference numbers refer to like constituent parts in the first and second embodiments, and a description of those parts is omitted.

An ink circulation path 7 of the present embodiment is configured so that an ink path 7c of a line connected to a sub-tank 6 branches into ink paths 7a and 7b in the middle. The ink path 7a branches off at a branch point 31 and is then connected to an ink port 4a of a recording head 4 through a pump communication path 7a5, pump 10, and ink feeding path 7a1. After branching, moreover, the ink path 7c is connected to an ink port 4b of the recording head 4 through an ink ejection path 7b.

In this arrangement, the ink circulation path 7 extends via the branch point 31, pump communication path 7a5, pump 10, ink feeding path 7a1, recording head 4, and branch point 31, in the order named, without covering the sub-tank 6. If the amount of the ink circulating in the ink circulation path 7 is reduced as the ink is discharged from the recording head 4, however, a negative pressure in the sub-tank 6 produced by the pump 10 increases through the ink path 7c. Thereupon, the ink in the sub-tank 6 is drawn up by the ink path 7c and introduced into the ink circulation path 7.

In the present embodiment, varying pressures that are produced as the pump 10 is driven, that is, positive and negative pressures just downstream and upstream, respectively, of the pump 10, both act on the branch point 31. Unlike the first embodiment, therefore, the present embodiment requires the driving direction of the pump to be determined according to the flow resistance distribution of the circulation path.

For example, the pump 10 of the present embodiment is configured so that pressures +P and −P are produced just downstream and upstream, respectively, of the pump 10 when the ink 2 is fed from the pump 10 so as to flow toward the ink feeding path 7a1. Thus, a pressure loss of 2 P is caused when the ink makes a complete circuit of the ink circulation path 7.

According to the present embodiment, let us assume that the diameter of the pump communication path 7a5 is relatively long, one pressure loss of P is caused in the pump communication path 7a5, and the other pressure loss of P is caused in the ink feeding path 7a1, recording head 4, and ink ejection path 7b. Thereupon, the pressure in the pump communication path 7a5 is on the negative side, and the pressures in the ink feeding path 7a1, nozzles 16, and ink ejection path 7b on the positive side.

Thus, if the flow resistance in the ink feeding path 7a1 from the pump 10 to the recording head 4 is less than the sum of those in the ink ejection path 7b from the head 4 to the branch point 31 and the pump communication path 7a5 from the branch point 31 to the pump 10, a negative pressure suitable for menisci can be produced in the nozzles by feeding the ink from the pump 10 toward the head 4 through the ink feeding path 7a1.

In consideration of these circumstances, the driving direction of the pump 10 is determined so that a suitable pressure for the discharge can be set in the nozzles 16. According to the present embodiment, the ink feeding direction of the pump 10 is a direction in which the ink 2 flows from the pump 10 toward the recording head 4 through the ink feeding path 7a1.

If the flow resistance in the ink feeding path 7a1 from the pump 10 to the recording head 4 is more than the sum of those in the ink ejection path 7b from the head 4 to the branch point 31 and the pump communication path 7a5 from the branch point 31 to the pump 10, on the other hand, a negative pressure suitable for menisci can be produced in the nozzles by feeding the ink from the pump 10 toward the head 4 through the pump communication path 7a5, branch point 31, and ink ejection path 7b.

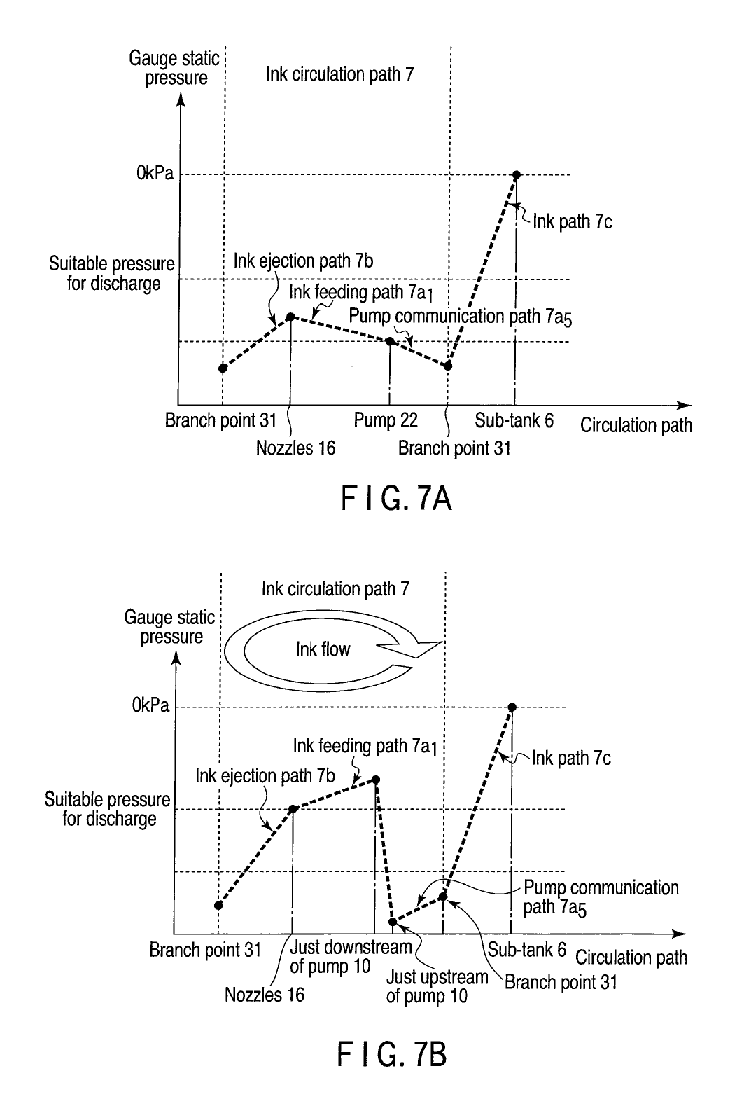

FIG. 7A shows a gauge static pressure distribution in an ink non-circulation state with the pump 10 off according to the second embodiment, and FIG. 7B shows a gauge static pressure distribution in an ink circulation state with the pump 10 on. In this case, the flow resistance per unit length is assumed to be uniform at every part.

In the non-circulation state with the pump 10 off, the ink stagnates and does not flow in the ink circulation path 7, so that the gauge static pressure of the sub-tank 6 is equal to the atmospheric pressure, the branch point 31 is at the lowest pressure, and the pressure in the nozzles 16 is less than an appropriate pressure for menisci, as shown in FIG. 7A. Thus, ink overflow is suppressed.

If the pump 10 is regarded as the start/end point of the circulation path, the pressure on the nozzles 16 on the upstream side relative to the ink flowing direction is raised and shifts to the positive-pressure side and the pressure at the downstream branch point 31 to the negative-pressure side as the pump 10 is driven, as shown in FIG. 7B. If the ink is circulated by the pump drive, the pressure on the nozzles 16 increases to a level for the formation of suitable menisci, whereupon the ink is discharged.

According to the present embodiment, based on the functions and effects of the first embodiment, the ink circulation path can be made shorter so that the ink path can be compactly led around, especially near the sub-tank.

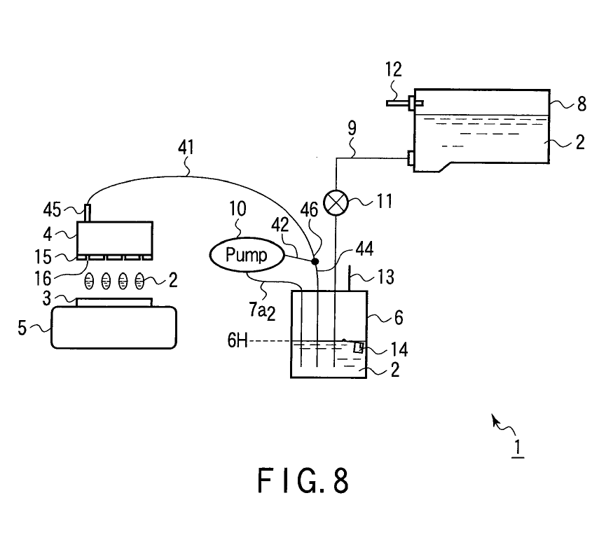

FIG. 8 is a block diagram showing a conceptual configuration example of an image recording apparatus according to a third embodiment of the invention. Like reference numbers refer to like constituent parts in the first and third embodiments, and a description of those parts is omitted.

Ink paths of the third embodiment differ from those of the first embodiment in that the ink feeding path connecting the pump and the ink port of the recording head according to the first embodiment connects the pump and the branch point in the middle of the ink ejection path. In the present embodiment, therefore, the pump circulates the ink in an ink circulation path between a sub-tank 6 and the branch point, not in the ink circulation path through which the ink flows into and out of the recording head. Thus, the ink is only supplied to the recording head through this ink path.

More specifically, an ink feeding path 41 (44) connects the sub-tank 6 and an ink port 45 of a recording head 4. Further, a branch point 46 is provided in the ink feeding path 41 near the sub-tank 6. A pump communication path 7a2 connects the sub-tank 6 and a pump 10. A pump branch communication path 42 connects the pump 10 and branch point 46. An ink circulation path of the present embodiment does not include the recording head 4 and comprises the pump 10, pump branch communication path 42, branch point 46, ink feeding path 44, sub-tank 6, and pump communication path 7a2.

In the present embodiment, the recording head 4 does not have an ink circulation function and the ink port 45 is singly used as an inlet. Thus, in the ink path through which the ink 2 is supplied to the recording head 4, the pressure of the ink flowing into the head 4 changes as the ink is circulated on this side of the head 4.

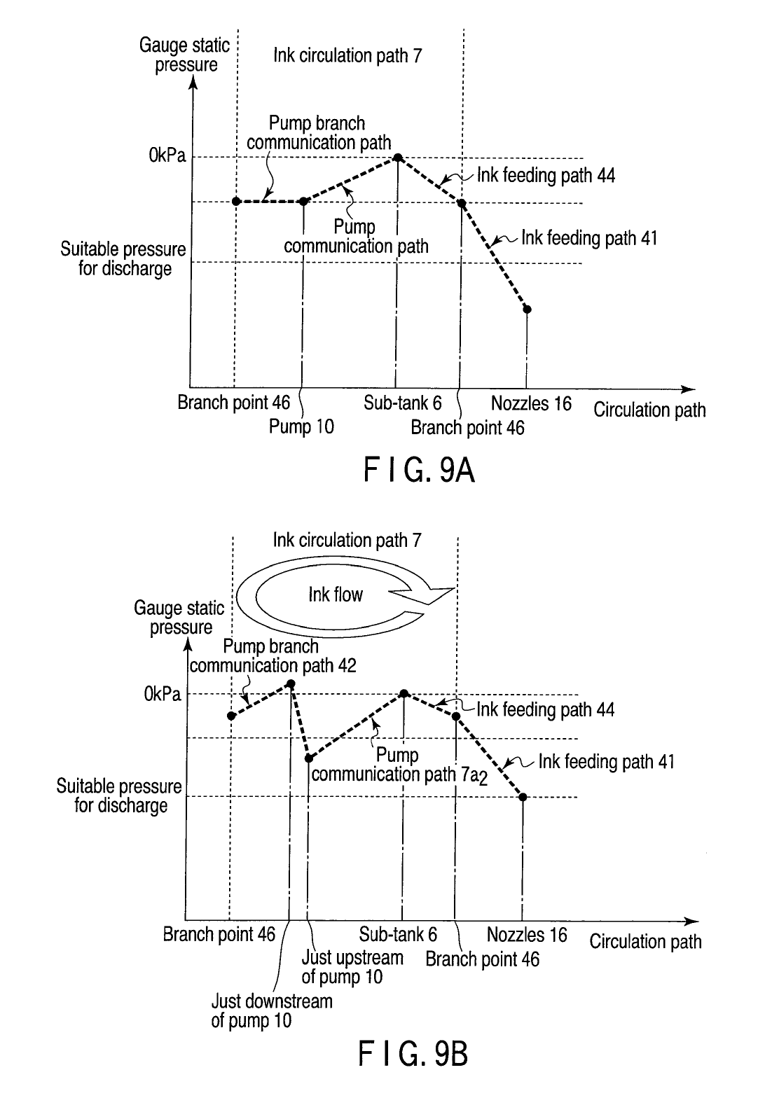

FIG. 9A shows a gauge static pressure distribution in an ink non-circulation state with the pump 10 off according to the third embodiment, and FIG. 9B shows a gauge static pressure distribution in an ink circulation state with the pump 10 on.

In the present embodiment, the ink stagnates and does not flow in the ink circulation path with the pump 10 off, so that the atmospheric pressure in the sub-tank 6 is the highest gauge static pressure, and the pressure in the nozzles 16 is less than an appropriate pressure for menisci, as shown in FIG. 9A. Thus, ink overflow is suppressed.

As the pump 10 is driven, the pressure at the branch point 46 is increased, so that the pressure in the nozzles 16 can be increased correspondingly, as shown in FIG. 9B. Thus, the pressure in the nozzles 16 can be increased to a suitable level for the discharge by driving the pump 10 so that the ink 2 flows from the pump toward the branch point 46.

The recording heads according to the first and second embodiments are limited to the ink circulation type through which the ink can be passed. According to the present embodiment, however, the ink does not need to be passed through the ink-jet recording head, so that more options are available for the selection of a general-purpose recording head.

According to the present embodiment, based on the functions and effects of the first embodiment, moreover, the ink circulation path can be made shorter so that the ink path can be compactly led around, especially near the recording head.

According to the present invention, there may be provided an ink-jet image recording apparatus capable of forming menisci suited for ink discharge during image recording while maintaining a sufficient difference between the respective height levels of an ink surface and nozzles without increasing the capacity of a sub-tank when the apparatus is off or on standby for recording.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An ink-jet image recording apparatus comprising:
a recording head comprising a plurality of nozzles which discharge an ink;
a sub-tank communicating with the recording head through an ink path member and stored with the ink;
a pump provided in the middle of the ink path member and configured to supply the ink in the sub-tank to the recording head,
the respective height levels of the surface of the ink in the sub-tank and the nozzles of the recording head and the surface of the ink in the sub-tank being set so that a pressure in the nozzles with the pump off is more negative than a negative pressure at which menisci for the ink discharge are formed,
the pressure in the nozzles being adjusted to the negative pressure at which the menisci for the ink discharge are formed by means of a positive pressure produced by the pump which is driven to discharge the ink from the recording head.

2. An ink-jet image recording apparatus according to claim 1, wherein the path member comprises a first ink supply tube and a second ink supply tube, the pump being located in the first ink supply tube, and a negative pressure at which a meniscus for the ink discharge is formed in each nozzle is set for each nozzle by feeding the ink from the pump toward the recording head during the ink discharge.

3. An ink-jet image recording apparatus according to claim 1, further comprising a pump path branching off from the ink path member, wherein the pump is located on the pump path.

4. An ink-jet image recording apparatus according to claim 3, wherein the pump adjusts the pressure in the nozzles to the negative pressure at which the menisci for the ink discharge are formed by feeding the ink from the pump toward the recording head during the ink discharge if a flow resistance from the pump to the recording head is less than the sum of that from the recording head to the branch point and that from the branch point to the pump.

5. An ink-jet image recording apparatus according to claim 3, wherein the pump adjusts the pressure in the nozzles to the negative pressure at which the menisci for the ink discharge are formed by feeding the ink from the pump toward the recording head through the branch point during the ink discharge if a flow resistance from the pump to the recording head is more than the sum of that from the recording head to the branch point and that from the branch point to the pump.

6. An ink-jet image recording apparatus according to claim 2,
further comprising a pump path branching off from the first ink supply tube, wherein the pump is located on the pump path and adjusts the pressure in the nozzles to the negative pressure at which the menisci for the ink discharge are formed by feeding the ink from the pump toward the branch point during the ink discharge.

7. An ink-jet image recording apparatus according to claim 1, wherein the ink path member constitutes an ink circulation path comprising an ink feeding path through which the ink is supplied to the recording head from the sub-tank located gravitationally lower than the position of the nozzles of the recording head with the pump therebetween and normally under the atmospheric pressure and an ink ejection path through which the ink ejected from the recording head is fed back to the sub-tank, and wherein a negative pressure is set to form menisci for ink discharge to the nozzles when the pump is driven to feed the ink from the pump toward the recording head so that the ink is circulated in the ink circulation path.

8. An ink-jet image recording apparatus according to claim 7, further comprising a second sub-tank located gravitationally higher than the sub-tank and lower than the position of the nozzles of the recording head, in the middle of the ink feeding path of the ink path member extending from the pump to the recording head, and normally under the atmospheric pressure, wherein menisci for ink discharge to the nozzles are formed when the pump is driven to feed the ink from the pump toward the recording head.

9. An ink-jet image recording apparatus according to claim 1, wherein the ink path member comprises a branch point at which an ink path led out of the sub-tank branches into an ink feeding path connected to the recording head through the pump and an ink ejection path through which the ink is fed back from the recording head to the sub-tank, the recording head, the ink feeding path, and the ink ejection path constituting a second ink circulation path with the branch point serving as a turn for ink feed, and wherein menisci for ink discharge to the nozzles are formed when the pump is driven to feed the ink from the pump toward the recording head so that the ink is circulated in the second ink circulation path.

10. An ink-jet image recording apparatus according to claim 8, wherein the menisci for ink discharge to the nozzles are formed by driving the pump to feed the ink toward the recording head if a flow resistance in the ink feeding path from the pump to the recording head is less than the sum of those in the ink ejection path from the recording head to the branch point and a path from the branch point to the pump.

11. An ink-jet image recording apparatus according to claim 1, wherein the ink path member comprises a first ink feeding path led out of the sub-tank, connected to the recording head, and configured to feed the ink, a second ink feeding path led out of the sub-tank and connected to the first ink feeding path through the pump, and a branch point at which the first and second ink feeding paths are connected to each other, the first and second ink feeding paths constituting a third ink circulation path with the branch point serving as a turn for ink feed, and wherein menisci for ink discharge to the nozzles are formed when the pump is driven to feed the ink from the pump toward the branch point so that the ink is circulated in the third ink circulation path.
